(19) United States
(12) Patent Application Publication
(10) Pub. No.: US 2016/0050128 A1
(43) Pub. Date: Feb. 18, 2016

(54) System and Method for Facilitating Communication with Network-Enabled Devices

(71) Applicant: Raco Wireless LLC, Cincinnati, OH (US)

(72) Inventors: ADAM SCHAIBLE, LOVELAND, OH (US); ROB CHIPMAN, BELLEVUE, KY (US); BEN KYRLACH, BATAVIA, OH (US); LEE ELMORE, NAPLES, FL (US)

(21) Appl. No.: 14/520,972

(22) Filed: Oct. 22, 2014

Related U.S. Application Data
(60) Provisional application No. 62/036,181, filed on Aug. 12, 2014.

(51) Int. Cl. H04L 12/26; H04L 29/08

(52) U.S. Cl. CPC H04L 43/062; H04L 67/22

(57) ABSTRACT

Systems and methods for communication between sensors and a cloud-based service are disclosed. The cloud-based service is configured to parse a message from the network-enabled device into one or more message elements, to obtain input related to selected message elements of the one or more message elements, and to generate an output format according to a message definition that includes the selected message elements. The cloud-based service is further configured to expose an application program interface for transmission of the message received from the network-enabled device according to the output format to one or more applications consuming the application program interface.

### CROSS-REFERENCE TO RELATED APPLICATIONS

This application claims priority to, and the benefit of, U.S. Provisional Patent Application No. 62/036,181, filed on Aug. 12, 2014 with the United States Patent and Trademark Office, which is incorporated herein by reference.

### BACKGROUND OF THE INVENTION

1. Field of the Invention

This application relates generally to communication with network-enabled devices and, more specifically, to data collection, data aggregation, and generation of application program interfaces related to network-enabled devices.

2. Description of Related Art

Hosted or cloud-based services exist for receiving messages from network-enabled devices, often referred to as Machine-to-Machine (M2M) or Internet of Things (IoT) devices. These services store data received from messages and provide one or more application program interfaces (APIs) accessible to developers to provide additional services built on the network-enabled devices. However, the types of devices compatible with these services and/or the types and forms of data collected and exposed by the APIs are generally predetermined by a service provider. Accordingly, developers are unable to configure such services to employ a variety of devices, to personalize data collection, and to customize the APIs.

### BRIEF SUMMARY OF THE INVENTION

A simplified summary is provided herein to help enable a basic or general understanding of various aspects of example, non-limiting embodiments that follow in the more detailed description and the accompanying drawings. This summary is not intended, however, as an extensive or exhaustive overview. Instead, the sole purpose of the summary is to present some concepts related to some example non-limiting embodiments in a simplified form as a prelude to the more detailed description of the various embodiments that follow.

In various, non-limiting embodiments, a system provides a collector of a web service that processes incoming traffic from a network-enabled device over a predefined communication channel, a parser that parses the incoming traffic into elements, a message definition manager that populates one or more message definitions using the elements, and a postprocessing manager that modifies at least a portion of at least one of the one or more message definitions through a scripted function to produce a final message definition.

In further embodiments, a method includes the steps of providing a collector via a web service that processes incoming traffic from a network-enabled device over a predefined communication channel, providing a parser that parses the incoming traffic into elements, providing a message definition manager that populates one or more message definitions using the elements, and providing a postprocessing manager that modifies at least a portion of at least one of the one or more message definitions through a scripted function.

In still further embodiments, another method includes receiving sensor data from a collector, parsing the sensor data into one or more tokens, populating one or more message definitions using the one or more tokens, transforming at least a portion of the one or more message definitions using scripted functions to produce commonly interpretable information, and transmitting the commonly interpretable information to one or more nodes using an API of a web service. The API can be defined at least in part by the message definitions and the scripted functions.

These and other embodiments are described in more detail below.

### BRIEF DESCRIPTION OF THE DRAWINGS

Various non-limiting embodiments are further described with reference to the accompanying drawings in which:

FIG. 1 illustrates a block diagram of an example, non-limiting system according to one or more aspects;

FIG. 2 illustrates a block diagram of modules used in conjunction with the system of FIG. 1;

FIGS. 3A and 3B illustrate an interaction flow depicting modules and sub-modules used in conjunction with aspects described herein;

FIG. 4 illustrates an example environment which can be used in conjunction with aspects disclosed herein;

FIG. 5 illustrates a flow chart of an example methodology for processing sensor data;

FIG. 6 illustrates a flow chart of an example methodology for processing sensor data; and

FIG. 7 illustrates a flow chart of an example methodology for defining sensor data processing routines.

Appendices A1 and A2 illustrate example interfaces for developing message definitions, scripts, and associated aspects for use therewith.

### DETAILED DESCRIPTION OF THE INVENTION

In isolation, modern devices with network capability can be time consuming to set up, maintain, and use. However, by enabling communication between devices (and/or the soft systems with which they communicate), the modern technological landscape has vast potential for interconnectivity and convenience among even casual end users.

To these ends, the devices must be capable of exchanging information interpretable by other systems. Transmissions from network-enabled devices are typically conducted according to network protocols, such as User Datagram Protocol (UDP), Transmission Control Protocol (TCP), variants thereof (Multipath TCP, Datacenter TCP, UDP-Lite), and emerging replacements (e.g., Stream Control Transmission Protocol, Internetwork Packet Exchange/Sequenced Packet Exchange, Quick UDP Internet Connections). The transmissions can be transmitted in bitstreams according to a variety of code conventions, and must be accepted, parsed, and interpreted out for use by components receiving the bitstreams.

In arrangements preceding the disclosures herein, a developer was typically required to code custom servers to receive information from each individual device based on its idiosyncratic communication conventions. This not only created substantial difficulty and risk of error in the transmission and reception of data, but also necessitated developers to maintain separate servers awaiting such configuration, increasing the burden and expense of development. The disclosures herein offer such benefits, and also contain the level of complexity, risk, and cost associated with the development end of integrating network-enabled devices.

As used herein, a “collector” is a module configured to receive transmissions from an individual device or sensor, or class of devices and sensors, implemented as one or both of hardware and software. The collector establishes or represents at least one communication channel which can be made to listen for communications from the sensor(s). A sensor is any electronic component capable of providing data which can be transmitted to a collector, and a device is an electronic apparatus capable of communication with a collector and operatively coupled with one or more sensors. Collectors can be (or can be implemented by) a combination of hardware and software as described herein.

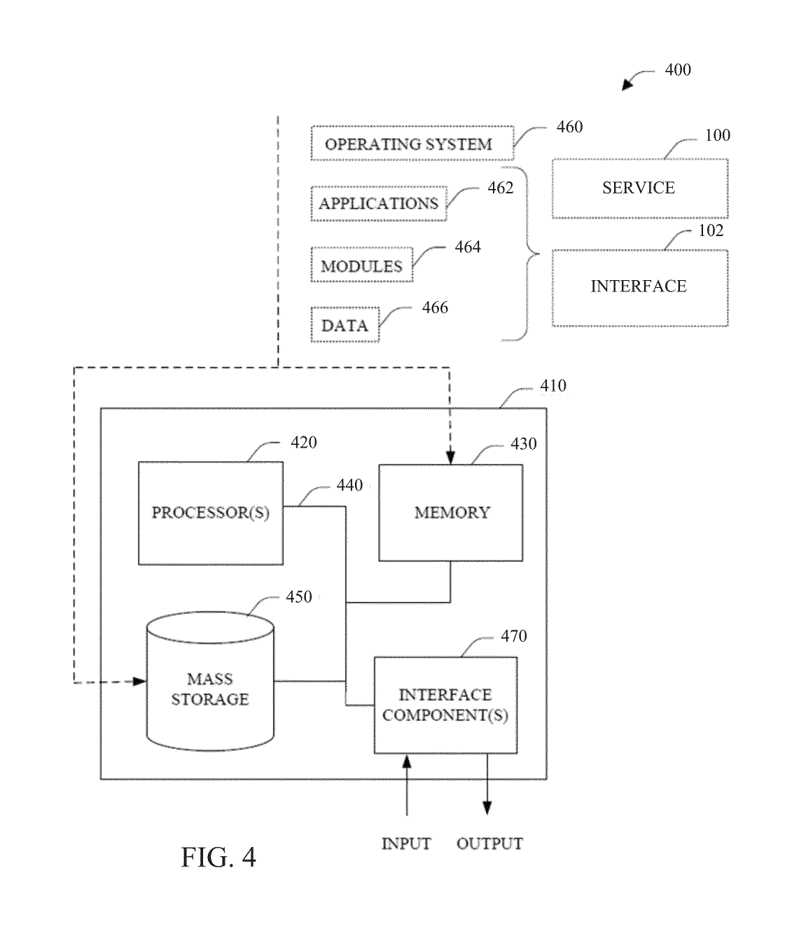

“Hardware” herein is intended to refer to physical electronic components, such as communication apparatuses, transmitters, receivers, random access memory, hard drives, routers, hubs, or lower-level components such as circuit elements. Corresponding elements are discussed in greater detail with respect to FIG. 4.

As used herein a “parser” is a component, which can be standalone or integrated in other components (e.g., collectors, communication components, message definition functions) for defining a continuous transmission from a sensor (e.g., a bitstream) in terms of one or more elements, or tokens, having a distinct portion of information contained therein. Parsers or associated components, such as pre-processing components, can prepare received bitstreams for parsing by decoding, decrypting, transforming, or otherwise modifying the information received before providing the information as parsed elements to other modules, devices, et cetera. Parsers can function, at least in part, based on the use of delimiters, which define breaks or segments in the transmission at which elements are parsed. A parser editor can be included in a parser or in conjunction with other functionality to permit the insertion or removal of delimiters to change the way in which particular streams of traffic are parsed.

A “message definition” is a reformatted or transformed portion of data comprising one or more parsed tokens and made available for use in later transmissions either in its parsed form or after concatenation, redaction, transformation, or other modification. The parsed tokens are developed from transmissions received through a collector.

A “component” or “module” herein can be any portion of hardware or software used in furtherance of corresponding aspects described. While modules are given particular names herein, it is understood that modules can be configured to perform other activity, and multiple modules be combined into a single module or a single module separated into multiple modules without exceeding the scope of the disclosure.

“Communication” herein can include any form of electric or electronic communication, via any technique or means, including wired connections or wireless techniques such as WiFi®, BlueTooth®, Zigbee®, cellular voice or data, satellite, et cetera.

As used herein, a “node” is any electronic or software component capable of receiving information over a network. Node is generally used as a term for a sensor, device, application (or “app” as colloquially used in reference to programs for cellular/tablet/mobile devices) capable of receiving information through or from APIs or services described herein. In some embodiments, the node can also send information (e.g., in request to a remote sensor accessible through the service, in response to a remote sensor accessible through the service, unrelated to a remote sensor accessible through the service), but two-way capability in reference to the service and/or other nodes is not required.

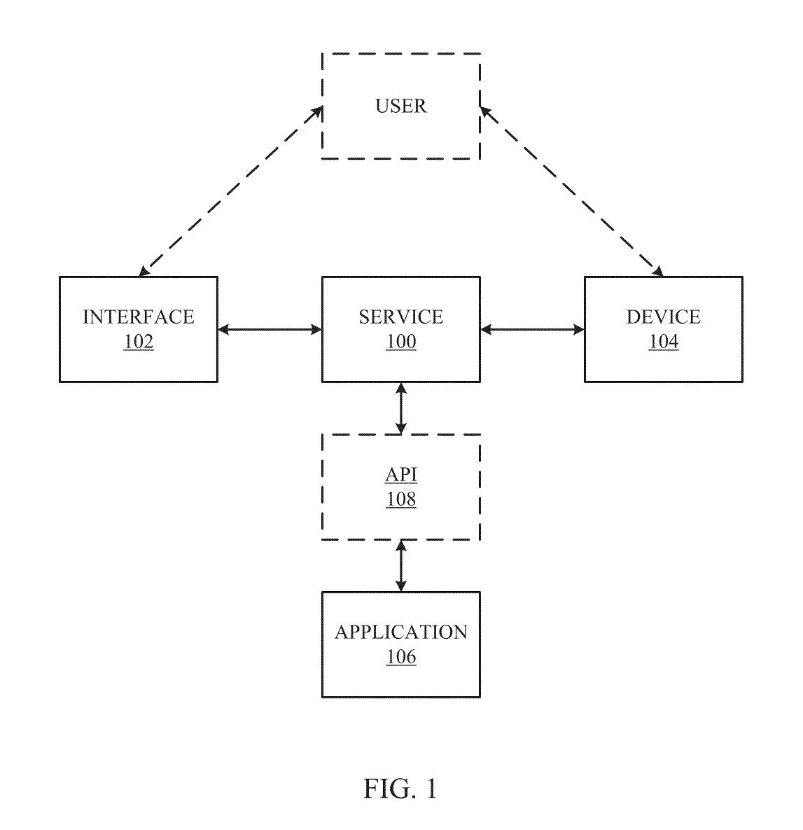

Embodiments of the invention relate to a cloud-based service for enabling communication with network-enabled devices (i.e., M2M or IoT devices) to facilitate data collection and dissemination to developers utilizing such devices to provide one or more applications and/or services. As shown in FIG. 1, through a web-based portal provided by a service 100, a developer can use interface 102 to establish a communication channel with a network-enabled device 104. The service 100 assigns an internet protocol (IP) address and a port number for communications with the network-enabled device 104. The network-enabled device 104 can be configured to transmit messages to the service 100 at the assigned address/port. Once a message is received, the service 100 can interpret the message based on at least a template message format. In an aspect, the service 100 can utilize heuristics or other machine learning and/or artificial intelligence techniques to parse and interpret the message. The developer can use interface 102 can select one or more message elements identified in the message for inclusion in an application program interface (API) 108 associated with the network-enabled device 104. From the one or more message elements selected, the service 100 generates a JavaScript object notation (JSON) output format for data retrieved via the API 108 associated with the network-enabled device 104. An application 106, created by a developer using interface 102 for example, utilizes the API 108 to retrieve data from the network-enabled device 104.

One or more APIs herein can be “RESTFUL” (representational state transfer) APIs (e.g., APIs that ignore syntax and component implementation thereby simplifying their employment). Further, as noted, use of the JSON output format provides an open standard format that uses human readable text to transmit data objects consisting of attribute-value pairs. In this way, integration of the service can be eased by leveraging transferable skills inasmuch as many developers are familiar with such aspects. However, while these implementations are described in terms of such specifications, alternatives will be apparent on review of this disclosure, and such examples should not be read as eliminating such alternatives.

In the architecture depicted in FIG. 1, service 100 can add device 104 on-demand (e.g., as requested by a user) or on-condition (e.g., traffic received) by establishing a collector to receive information from device 104. The collector can be a server (e.g., logical server associated with service, dedicated hardware server specific to collector, other network device for managing communications related to device(s) for which collector listens) which is established (on demand or on condition) and listens for data (e.g., sensor data, other information) from device 104. In embodiments, a collector may be instantly established, or may alternatively be established on the occurrence of a demand or specific condition, or may be established after a series of conditions or affirmative action by a user based on demands or conditions. In at least one embodiment, listening can occur at a specific predetermined logical location (e.g., on a specific port) or over a range of logical locations. Interface 102 can be used to build, enable, disable, or otherwise modify such servers. The servers hosting collectors for service 100 can be dedicated physical servers or shared servers, and are provided through service 100 without requiring installation or provisioning by users assessing service 100 through interface 102.

One or more servers of service 100 can function as collectors for one or more devices including device 104. Collectors are a node (comprising hardware, software, or a combination thereof) to which a particular device or classes of devices can send traffic. Collectors can be configured to listen on a port or range of ports. Collectors can, in embodiments, listen for traffic according to a protocol used by the device. The collector is configured based on the hardware of device 104. Collectors can be dedicated to a single device 104 (e.g., one iPhone®), all devices similar to device 104 (e.g., all iPhone® 6 models), or a class of devices like 104 (all iPhone® devices).

Other examples of devices which can interface with these systems include devices by CalAmp® or Queclink®. CalAmp® produces a variety of tracking and telemetry devices, routers and gateways, private radio and narrowband equipment, and satellite reception products, and interfaces with other devices to facilitate fleet and asset management, network management, et cetera. Queclink® provides location tracking devices for assets, vehicles, and individuals, utilizing both proprietary and off-the-shelf hardware. In this regard, collectors can be dedicated to an entire class of devices (e.g., all asset tracking devices including those provided by CalAmp®, Queclink®, and others), a particular solution provider (e.g., CalAmp®, Queclink®, or others), a particular hardware provider (e.g., CalAmp®, Queclink®, or others), or a specific hardware device (e.g., Queclink® GT200). These examples are only provided to discuss other possible devices and/or sensors, and on review of the disclosures herein it will be understood that such description is not exhaustive but only intended to describe a few of the virtually countless devices or sensors from which data can be collected.

As suggested above, collectors can be added to service 100 through a request in a user interface or automatically upon receipt of traffic. Where the collector is generated on-demand, the collector may be automatically configured, or configuration may occur through a guided (e.g., wizard-type) process. Collectors can be named (e.g., provided an alias) and have various parameters or information viewed or edited through interface 102.

In the configuration of a collector, various preprocessing related to the collector of service 100 and/or device 104 can be completed. For example, various parameters related to a security handshake can be pre-populated or provided upon the initial exchange of information. Additional pre-processing steps can be performed or pre-populated to ensure interpretable communication between collector(s) and device 104 (or other sensors/devices).

Collectors of service 100 can include binary support in the form of binary decoders which progressively decode transmissions received from sensors. Because some sensors (e.g., device 104) may send binary data, rather than plain text, the bitstreams must be decoded prior to parsing, interpretation, or further use. Service 100 (or other modules) can select the way in which bitstreams are parsed (e.g., 4-byte resolution) to assist with decoding binary or other information received in formats other than plain text.

Device 104 can be communicatively connected to service 100 in any appropriate fashion. In an embodiment, device 104 can be connected via a hardwired connection to a computing device hosting or in communication with service 100. Alternatively, device 104 can be connected wirelessly using one or more wireless communication techniques. Communication can occur using protocols such as TCP or UDP, or according to other native device capabilities (e.g., short message service). More than one means of communication can be leveraged to receive information, send information, and perform other interaction. More than one means of communication can also be used to control transmission and reception to and from a variety of sensors.

Initial contact with device 104 can be manually established by a user of device 104 in accordance with the standard operation or specifications of device 104. In alternative or complementary embodiments, device 104 can be configured to automatically establish contact upon connection, or one of device 104 and/or its collector(s) can broadcast information (at all times or upon specific conditions) to enable exchange of data. In still further embodiments, a pre- or later-installed application on device 104 can be used to effect communication between device 104 and a collector. In embodiments, applications or modules within service 100 or device 104 can be used to emulate signals for configuration and testing of collectors.

After contact is established over a predetermined or detected port, the collector of service 100 recognizes device 104 (or other sensors/devices) according to a unique identifier and other parameters received about device 104 which can be stored in a sensor database of service 100. In at least on embodiment, the unique identifier can be based at least in part on the device's International Mobile Station Equipment Identity (IMEI), serial number, or another portion of unique information stored within the device. Where no unique information exists in specific regard to a sensor, service 100 can interrogate information stored within the sensor (on first contact or on a rolling basis where sensor memory is overwritten) to establish a unique identifier for the sensor based on the sensor data (which will likely be different than that stored to other sensors), and/or attempt to push unique identifier information to the sensor where service 100 has write permission on the sensor. A sensor list can contain a variety of properties, such as identifier or alias, amount or frequency of traffic, previous traffic sent, sensor information such as technical specifications or capabilities, and other data. The sensor list can be searched, called, or displayed, and facilitate editing of specific sensor properties, using interface 102.

Information received from sensors (including but not limited to device 104) by collectors can be mapped according to its contents. The mapped contents are automatically parsed according to particular pieces of information based on breaks within the content, pre-programmed strings (e.g., recognition of particular types of sensor data such as temperature or location), string recognition (e.g., based on similarity to pre-programmed strings), or artificial intelligence techniques for identifying particular subsections of transmissions.

Parsed information from sensors (e.g., device 104) can be provided to the user in interface 102. The user can select types of data to retain (e.g., indicated to “include” in a library related to a sensor or collector) or discard, and then assemble particular message definitions or other specific groups of information (e.g., indicated to “save” into a particular message definition) out of retained data. Interface 102 can be used to create new message definitions through selection of parsed data portions and postprocessing script which modifies the data portions' properties, transforms the data portions, uses the data portions in calculations, or completes other action using the data portions. Message definitions can be reviewed and revised after creation using a “settings” sub-interface associate with message definitions or other modules.

In embodiments, an “ignore” message definition can be associated with parsed data not indicated to be retained to ensure full accountability of all message contents. Data from the “ignore” message definition desired at a later time can be accessed by removing the particular data from the “ignore” message definition and adding it to another message definition.

Once message definitions are established, user interface 102 can also be leveraged to provide a development environment permitting users to write scripts to run on the collector of service 100 or device 104 itself in furtherance of leveraging device 104 through service 100. The development environment can be, for example, a JavaScript® coding environment where the user can provide various messages or instructions to be sent to or run on the sensors. By leveraging existing scripting environments and languages, transferable skills of developers can be leveraged, minimizing familiarization and training with interface 102. The scripts can utilize various message definitions or portions of data in isolation.

The development environment can be implemented as one or more postprocessing modules. A postprocessing module can be used to define rules (e.g., what to do with data, how to disambiguate data), triggers (e.g., what causes action, how to send back to sensor), or other automated routines. Conditions can be programmed in the postprocessing module to provide programmatic Boolean expressions related to sensor data, message definitions, or information derived there from. Script or other instructions need not be limited to such forms or definitions (e.g., rules and triggers), and can take on any form or function supported. In addition, postprocessing script can be pre-populated with text related to the functions already accomplished in building the message definition. For example, script for accomplishing the coded effect of use of the drag-and-drop functionality from interface can be provided with other script added manually by the user or through other functions.

Service 100 can operate according to varying levels of feedback from device 104. For example, in some instances, no response is required for data sent or received. In other embodiments, an acknowledgment must be provided from device 104 to service 100 via a corresponding collector or server in response to a particular transmission or action. Varying combinations or alternatives of responses, acknowledgements, and confirmations in response to one or more activities are embraced herein without limitation.

During development of communication architectures, APIs, and/or applications, inconsistencies in transmission content may arise resulting in errors in communication or processing. When transmissions between device 104 and service 100 result in exclusively interpretable and/or usable content, these transmissions can be indicated as “hits.” When transmissions between device 104 and service 100 result in at least some non-interpretable and/or non-usable content (e.g., unable to parse, no message definition utilizing content), the transmission or portions thereof can be indicated as one or more “misses.” “Hits” and “misses” can be tracked according to data sent and/or received, and/or acknowledgments exchanged. Misses can trigger an alert through interface 102 or other means, and/or be logged (with or without generating an alert). Misses can be diagnosed and identified for further treatment automatically (e.g., service 100 seeks resolution after receipt of miss without further action) or manually (e.g., user responds to notification or reviews miss log). Unparseable data can be reviewed for proper parsing or identification and/or associated with message definitions to ensure no information is undesirably lost or ignored. Artificial intelligence or predefined routines can be utilized to identify unparseable or data unrecognized in reference to message definitions and storing such in an appropriate location for review.

Session constants can be established or utilized during communication. Session constants are shared data elements between device 104 and service 100 and can be used for reporting a unique identifier of device 104 and ensuring traffic is properly routed to and from device 104 (e.g., maintaining knowledge of source and target). Session constants can be persistent data in service 100 or be removed at the end of a session (e.g., on disconnect of device 104, after a timeout period).

An API can be built or generated in a partially or wholly automated fashion using information from service 100 and/or device 104. The API can be RESTFUL and facilitate communication of information from device 104 to various nodes in communication with service 100.

Once information about device 104, collectors, and other elements is populated in service 100, interface 102 can provide one or more list interfaces to display the various settings or configurations for the service and their properties. Interface 102 provides a visual representation of several logical elements such as message definitions, and can include at least one code editor in the form of an editable text window facilitating changing of the settings or configurations or scripts run on portions of data managed by service 100.

In this fashion, a device 104 can be connected to a service 100 to facilitate use of its sensors and enable communication between device 104 and various other networked devices. Information from sensors including or provided in device 104 can be used so long as connectivity is present to enable interaction between network-capable devices and use of information available to any network-capable device rather than being limited to the single device being used.

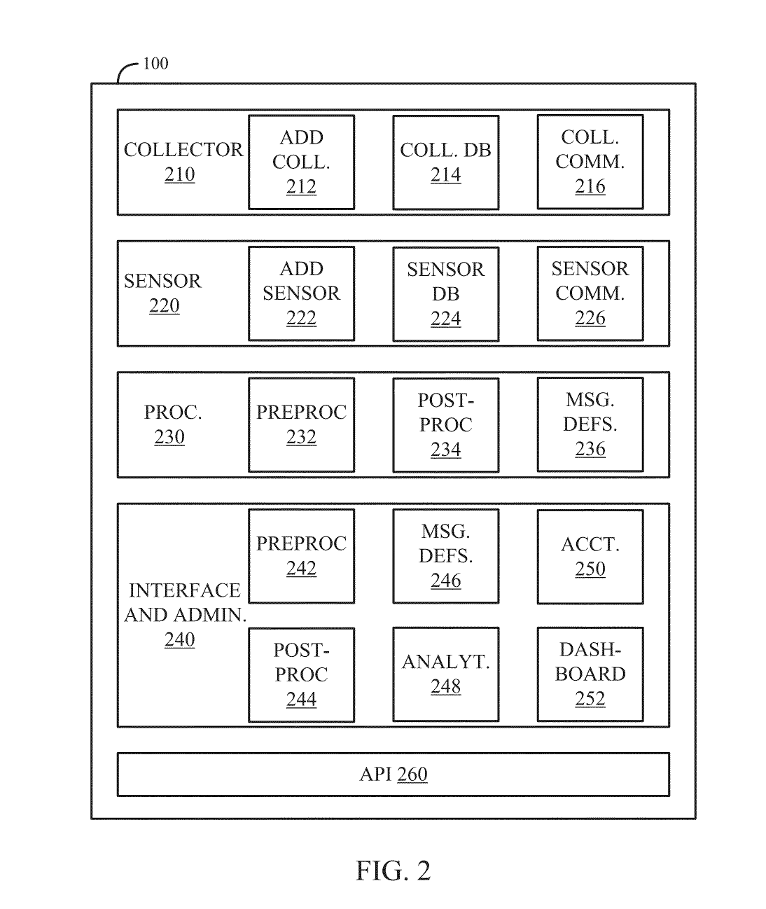

FIG. 2 illustrates an example embodiment of service 100. Service 100, in the illustrated embodiment, includes a plurality of modules capable of effecting the functions described above with respect to FIG. 1.

Service 100 includes collector management module 210 which is used to manage collectors associated with service 100. Collector management module 210 is associated with add collector module 212, collector database module 214, and collector communication module 216.

Add collector module 212 comprises software and/or hardware for creating a new collector in service 100, leveraging the electronic and/or software routines to allocate resources for the collector and begin listening over the port(s) or according to communication techniques in accordance with sensors from which it collects. Add collector module 212 can further provide information or be leveraged by interface and administration module 240 to provide details to facilitate display of elements representing addition of a collector in service 100.

Collector database module 214 stores information about active collectors, as well as information regarding inactive collectors (e.g., added but not currently running to receive traffic) and/or collector models (e.g., default collector information for known devices which can be added pre-populated with device-relevant data to expedite the adding process). Collector database module 214 can further provide information or be leveraged by interface and administration module 240 to provide details to facilitate display of elements representing addition of a collector in service 100.

Collector communication module 216 manages communication between collector modules and other hardware or software in or interacting with service 100 and coordinate activity of related modules. Collector communication module 216, alone or in conjunction with another module, can parse incoming traffic to permit individual message components to be included, saved, or otherwise segregated for use (e.g., used individually in functions or processes, incorporated into composite definitions, disregarded). Collector management module 210 can include a separate parser for one or more collectors in embodiments. Users can modify parsing activity or other modification of incoming traffic through the use of manually added delimiters or through pre-processing scripts.

Service 100 also includes sensor management module 220 which is used to manage sensors (e.g., device 104 or subcomponents thereof) associated with service 100. Sensor management module 220 is associated with at least sensor module 222, sensor database module 224, and sensor communication module 226.

Add sensor module 222 comprises software and/or hardware for adding a new sensor in service 100, leveraging the electronic and/or software routines to allocate resources to receive and process communications from a new sensor, prompting the sensor to transmit and/or providing acknowledgements when relevant. Add sensor module 222 can further provide information or be leveraged by interface and administration module 240 to provide details to facilitate display of elements representing addition of a collector in service 100.

Sensor database module 224 stores information about active sensors (e.g., currently or expected-to-be in communication), as well as information regarding inactive sensors (e.g., not currently connected or sending traffic, associated with an inactive collector) and/or sensor models (e.g., default sensor information for known devices which can be added pre-populated with device-relevant data to expedite the adding process). In embodiments, previous traffic, or all traffic, and/or other collateral sensor information (e.g., signal strength, average bandwidth, sensor health) can also be stored using sensor database module 224. Sensor database module 224 can further provide information or be leveraged by interface and administration module 240 to provide details to facilitate display of elements representing addition of a collector in service 100.

Sensor communication module 226 manages communication between sensor modules and other hardware or software in or interacting with service 100.

Service 100 includes processing management module 230 which can be leveraged in combination with various other modules to ensure appropriate information and commands are exchanged between sensors, collectors. Processing management module 230 is associated with at least preprocessing module 232, postprocessing module 234, and message definitions module 236.

Preprocessing module 232 can be used to populate, generate, or otherwise manage any information required in advance of data exchange between a collector (e.g., active collector in collector database 214) and a sensor (e.g., active sensor in sensor database module 224). For example, authentication or handshake procedures, decoding or parsing information, or any other configuration required prior to the exchange of all relevant content can be effected through preprocessing module 232. Preprocessing information used by preprocessing module 232 can be provided through preprocessing interface module 242 to show scripting, visually depict the effect of actions taken in processing, et cetera. In embodiments, preprocessing module 232 is configured to interpret JSON.

Postprocessing module 234 can be used to perform actions after receipt of content exchanged between collectors, sensors, and/or other components of or in communication with service 100. Postprocessing module 234 executes scripts on data transmitted among sensors or other components of or in communication with service 100. For example, sensor data received can be transferred, transformed, combined, used in calculations, provided as the variable of a function, provided as text for display, et cetera, according to instructions executed by postprocessing module 234. Postprocessing information (e.g., scripts) used by postprocessing module 234 can be provided through postprocessing interface module 244. In embodiments, postprocessing module 234 is configured to interpret JSON.

Processing management module 230 is further associated with message definitions module 236. Message definitions module 236 manages message definitions and applies message definitions to incoming traffic. For example, if traffic from a Global Positioning System capable device includes a device identifier, a current location, a previous location, and a heading, these pieces of information can be parsed into individual data points for incorporation into a message definition. A location log of a message definition can disregard heading, but include and save current location and previous location. Locations can be parsed into further subsets of information, such as (for example) latitude, longitude, and altitude, each discrete portion of which is then managed using message definitions module 236. Message definitions can further include a variety of built-in and custom properties and parameters, and can store additional details regarding the message definition and modules interacting therewith (e.g., source of variable data, variable type such as string or integer).

Service 100 further comprises interface and administration module 240. Interface and administration module 240 facilitates user interaction and controls access to user data or information. Interface and administration module 240 is associated with at least preprocessor interface module 242, a postprocessing interface module 244, a message definitions interface module 246, analytics module 248, and an account module 250.

Preprocessor interface module 242 and postprocessing interface module 244 provide sub-interfaces, which can include drag-and-drop functionality, menus, buttons, scripting windows, or other interface parts that facilitate the user's provisioning or creation of preprocessing or postprocessing routines or functions for application to communication from sensors. With these instructions developed, preprocessing module 232 and postprocessing module 234 execute such pre- and post-processing on received data from sensors.

In addition, allowing the creation of new preprocessing and/or postprocessing elements, preprocessor interface module 242 and postprocessing interface module 244 can display various tables with names or aliases for pre- and post-processing routines or functions to permit review, editing, copying, activation or deactivation, and otherwise modifying the way in which preprocessing or postprocessing occurs using service 100.

Message definitions interface module 246 provides user interfaces for creating and managing message definitions used by message definitions module 236. Message definitions interface module can display parsed communication content, including both interpretable and uninterpretable (e.g., “misses”) strings, and permit users to copy, paste, or modify portions of communications used in message definitions. In embodiments, message definitions interface module can provide drag and drop functionality whereby parsed elements of communication can be visually placed in logical positions visually depicting their significance in communication or processing. Development can be accomplished by way of built-in functionality (e.g., service 100 configured with auto-forward function which provides identified portion to another device), custom functionality (e.g., by way of postprocessing/scripting developed by user), or other techniques. The interface can provide a visualization of the parsed elements and other aspects used to build message definitions and APIs, offering a “what-you-see-is-what-you-get” display that increases the developer's speed and understanding of the results to be accomplished. Composite message definitions can be developed by dragging different parsed portions together into concatenations represented by showing the different parsed portions commonly placed in a portion of the message definitions interface module.

In addition allowing the creation of new message definitions and/or managing handling of parsed communication portions, message definitions interface module 246 can display various tables with names or aliases for pre-existing standard or custom message definitions to permit review, editing, copying, activation or deactivation, and otherwise modifying the way in which message definitions are applied.

Analytics module 248 is also provided with interface and administration module 240. Analytics module 248 can generate data related to, for example, message flow (e.g., order of communications between devices, how received data travels in one or more communications, where collector or device repeat in processes or techniques). Analytics module 248 can also generate or aggregate data related to collector traffic, parser activity, message definition usage, pre- or post-processing script or function usage, hits and misses, and other statistics related to functioning of service 100 (including both built-in and custom-developed functionality).

Account module 250 manages user accounts. Because service 100 can be hosted remotely (e.g., software as a service) or locally on shared devices (e.g., running on a computer physically located on-site with devices capable of sharing by multiple users), accounts can be set up to secure user information and information about devices or processing developed by the user. Account module 250 can segregate data specifically associated with one user (e.g., device identifiers, sensor data, user information, authentication information) from others and require the user to log in before access is granted. Other information (e.g., contact, billing, related services, account notes) can also be managed by account module 250.

Dashboard module 252 includes other elements of the user interface navigation between the modules listed and other aspects of service 100. For example, dashboard module 252 can dictate the whole-screen layout of interface elements, and provide buttons, links, tabs, et cetera for moving between different functions or modules (e.g., button for account, button for message definitions).

In embodiments, interface and administration module 240 can be hosted as a service accessible to a user through a browser or application. Dashboard module 252 provides initial screens upon log-in/start-up and swaps to or populates other interfaces or module data based on user interaction.

API module 260 provides connectivity to other hardware or software outside service 100 and can provide information from service 100 to such hardware or software for utilization or consumption. For example, various “smart” appliances in a house can be coordinated through a controller or share information with one another to avoid exceeding a maximum electrical load. Therefore, sensors associated with each appliance can report to service 100 through collector management module 210 and, after population through message definitions module 236 and/or any pre- or post-processing through preprocessing module 232 and/or postprocessing module 234, pulled from or pushed to sensors or modules using API module 260 to provide information sharing among the appliances. In this fashion, service 100 not only standardizes and focuses incoming bitstreams, but can provision the resultant data to other sensors in communication with service 100. While API module 260 is shown as a single module, it is understood API module 260 (like other modules herein) can be implemented as a plurality of APIs.

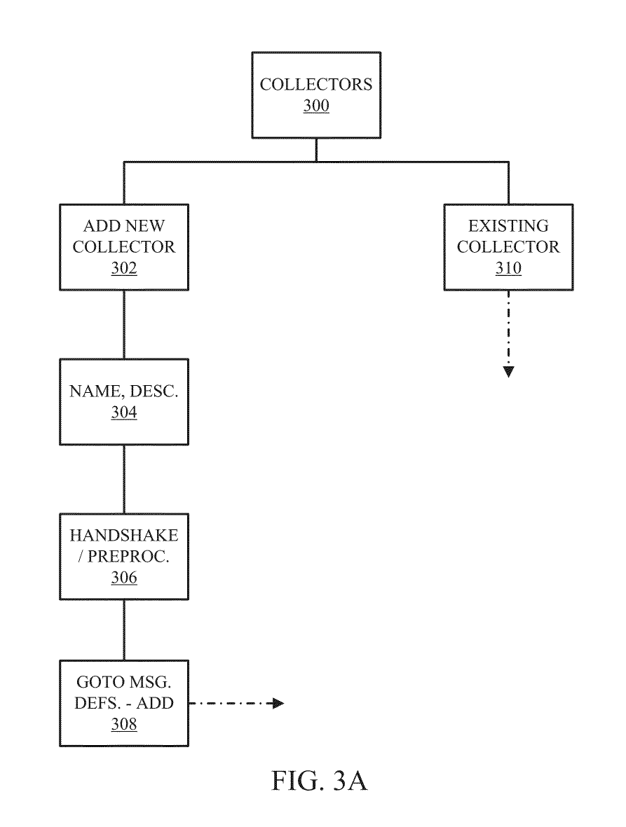

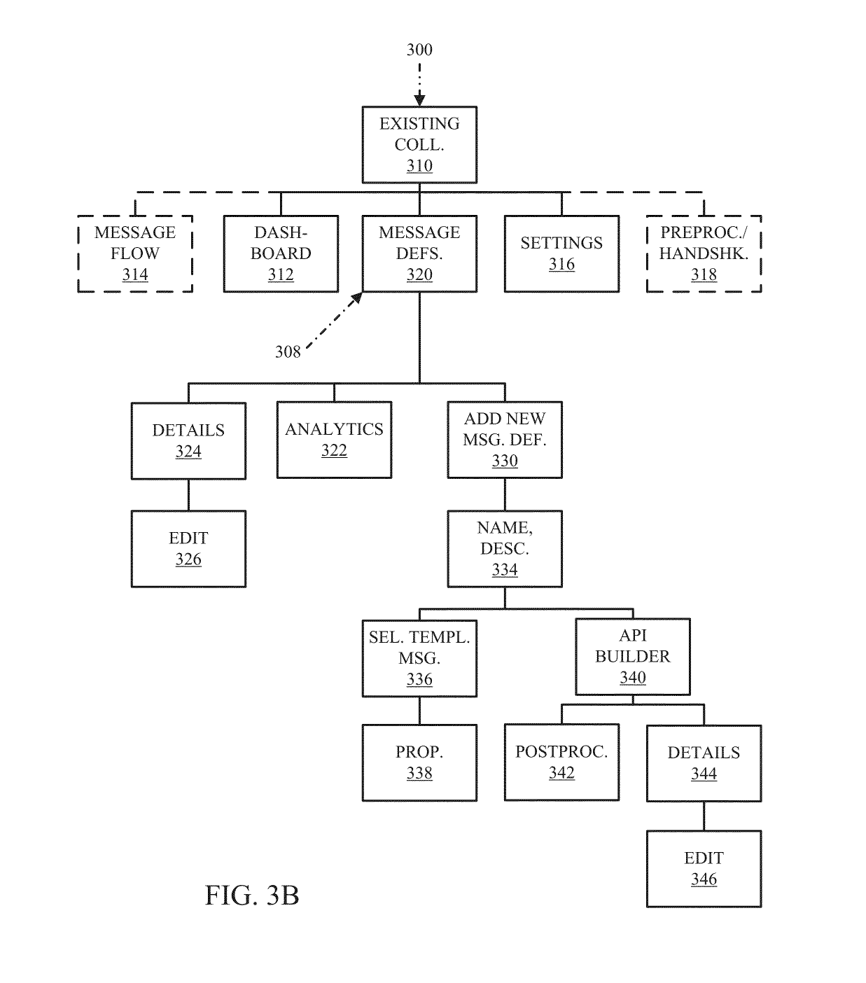

FIGS. 3A and 3B illustrate a function tree directed toward collectors in systems and methods here. The function tree includes various programmatic functions which can be associated with a portion of a shared interface (with other functions), trigger use of a new interface, or run invisibly without impacting a user interface. The function tree has its base node at collectors 300, which splits into add new collectors 302 and existing collectors 310.

Add new collectors 302 is called when a new collector is to be created or added to collectors 300 for use with systems and methods herein. The initial call to add new collectors can include identifying a type of collector or type of device with which the collector will function, and/or other information which determines how the new collector will communicate. Name and description 304 is called to provide a name, alias, and other identifying information permitting users to discern the new collector from others. Handshake/preprocessing 306 is called to ensure the basic setup required between the collector and device(s) for which it will listen is arranged to permit the device(s) to authenticate and/or communicate in an interpretable fashion. With the collector named and described, and handshake/preprocessing complete, the collector can be treated as an existing collector, and goto message definitions/add message definitions 308 is called which in turn calls message definitions 320.

Regarding the existing collector 310 branch, several related functions are provided. Dashboard 312 provides a user interface and navigation organization for users to employ. Settings 316, which can be reached through dashboard 312 or other interface aspects related to an existing collector, permit the user to change settings related to the collector. Optionally, an additional function preprocessor/handshake 318 can be provided, alone or in combination with settings 316. Also, in some embodiments, message flow 314 or other analytics can be provided with respect to an existing collector to provide statistics or information regarding the activity or performance of the collector.

Message definitions 320 provides functionality for management, analysis, and creation of new message definitions. Analytics 322 provides specific statistical analysis, which can be stored, exported, or displayed in graphical representations, related to the usage of specific message definitions. Details 324 provides an opportunity to review existing message definitions or data assigned to successive uses of message definitions. From details 324, message definitions can be modified using the function edit 326.

The function to add new message definition 330 first calls the function to provide name and description 334 for the new message definition. After sufficient identifying information is provided, select template message definition function 336 can be invoked to set up a predefined message definition (e.g., based on previously set-up definition or known device with known intended uses). Select template message definition 336 can provide a properties 338 function to show the properties and/or other information relating to the selected message definition template, before and/or after selection to facilitate user understanding of the template.

If a user chooses to define a new message definition not based on a template, API builder 340 is employed. API builder 340 provides the ability to move and perform processing actions on parsed tokens, either through a visual interface or code, for arrangement as a message definition. The message definitions (subsequent to any post-processing) define the form through which service, sensors, and/or any applications leveraging the service communicate. API builder 340 can access postprocessor 342 functionality, which permits the integration of any postprocessing script desired by a user to be run on one or more tokens comprising the new message definition. API builder 340 can also invoke details 344, which shows details of existing APIs (e.g., message definitions, parsing delimiters, pre- or post-processing script). Details 344 facilitates editing of such aspects using edit 346.

Whether utilizing a message definition managed by message definitions 320 function, or mapping a communication to create a new message definition using add new message definition 330, incoming traffic from a sensor through a collector can be broken into tokens during parsing. The message is mapped to define the particular tokens, each comprising a portion of the parsed traffic. At least a portion of the parsed traffic is then populated into message definitions, on which post processing scripts can be run. Each message definition can (but need not) have its own unique post processing scripts for utilizing tokens before the information is passed forward through the service or among devices.

Using these techniques, information can be collected from a variety of sensors. The information may be pre-processed, and is parsed. The parsed data is populated into various message definitions, and then may be post-processed and stored (temporarily or permanently) for further provisioning. Pre- and post-processing can be conducted at least in part utilizing JSON. The stored data can be provided to applications or other devices using an API developed from the message definitions, processing, and/or sensor information. The API can be RESTFUL and be leveraged through a web service and/or various network-capable devices.

In order to provide a context for the claimed subject matter, FIG. 4 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed systems and methods can be described in the general context of computer-executable instructions of a program that runs on one or more computers or network hardware, those skilled in the art will recognize that aspects can also be implemented in combination with various alternative hardware, software, modules, et cetera. As suggested earlier, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant, portable gaming device, smartphone, tablet, Wi-Fi device, laptop, phone, among others), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 4, illustrated is an example general-purpose computer 410 or computing device (e.g., desktop, laptop, server, hand-held, programmable consumer or industrial electronics, set-top box, game system, et cetera). The computer 410 includes one or more processor(s) 420, memory 430, system bus 440, mass storage 450, and one or more interface components 470. The system bus 440 communicatively couples at least the above system components. However, it is to be appreciated that in its simplest form the computer 410 can include one or more processors 420 coupled to memory 430 that execute various computer executable actions, instructions, and or components stored in memory 430.

The processor(s) 420 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 420 may also be implemented as a combination of computing devices, for example a combination of a DSP and a microprocessor, a plurality of microprocessors, multi-core processors, one or more microprocessors in conjunction with a DSP core, or any other such configuration.

The computer 410 can include or otherwise interact with a variety of computer-readable media to facilitate control of the computer 410 to implement one or more aspects of the claimed subject matter. The computer-readable media can be any available media that can be accessed by the computer 410 and includes volatile and nonvolatile media, and removable and non-removable media. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to memory devices (e.g., random access memory, read-only memory, electrically erasable programmable read-only memory, et cetera), magnetic storage devices (e.g., hard disk, floppy disk, cassettes, tape, et cetera), optical disks (e.g., compact disk, digital versatile disk, et cetera), and solid state devices (e.g., solid state drive, flash memory drive such as a card, stick, or key drive, et cetera), or any other medium which can be used to store the desired information and which can be accessed by the computer 410.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Also, a connection can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above can also be included within the scope of computer-readable media.

Memory 430 and mass storage 450 are examples of computer-readable storage media. Depending on the exact configuration and type of computing device, memory 430 may be volatile (e.g., RAM), non-volatile (e.g., ROM, flash memory, et cetera) or some combination of the two. By way of example, the basic input/output system (BIOS), including basic routines to transfer information between elements within the computer 410, such as during start-up, can be stored in nonvolatile memory, while volatile memory can act as external cache memory to facilitate processing by the processor(s) 420, among other things.

Mass storage 450 includes removable/non-removable, volatile/non-volatile computer storage media for storage of large amounts of data relative to the memory 1030. For example, mass storage 450 includes, but is not limited to, one or more devices such as a magnetic or optical disk drive, floppy disk drive, flash memory, solid-state drive, or memory stick.

Memory 430 and mass storage 450 can include, or have stored therein, operating system 460, one or more applications 462, one or more program modules 464, and data 466. The operating system 460 acts to control and allocate resources of the computer 410. Applications 462 include one or both of system and application software and can exploit management of resources by the operating system 460 through program modules 464 and data 466 stored in memory 430 and/or mass storage 450 to perform one or more actions. Accordingly, applications 462 can turn a general-purpose computer 410 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, service 100 (or portions thereof) and/or an instance of interface 102 (or portions thereof) can be, or form part, of an application 462, and include one or more modules 464 and data 466 stored in memory and/or mass storage 450 whose functionality can be realized when executed by one or more processor(s) 420.

In accordance with one particular embodiment, the processor(s) 420 can correspond to a system on a chip (SOC) or like architecture including, or in other words integrating, both hardware and software on a single integrated circuit substrate. Here, the processor(s) 420 can include one or more processors as well as memory at least similar to processor(s) 420 and memory 430, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the service 100 (and/or associated functionality) and/or interface 102 (and/or associated functionality) can be embedded within hardware in a SOC architecture.

The computer 410 also includes one or more interface components 470 that are communicatively coupled to the system bus 440 and facilitate interaction with the computer 410. By way of example, the interface component 470 can be a port (e.g., serial, parallel, PCMCIA, USB, FireWire, et cetera) or an interface card (e.g., sound, video, et cetera) or the like. In one example implementation, the interface component 470 can be embodied as a user input/output interface to enable a user to enter commands and information into the computer 410 through one or more input devices (e.g., pointing device such as a mouse, trackball, stylus, touch pad, keyboard, microphone, joystick, game pad, satellite dish, scanner, camera, other computer, et cetera). In another example implementation, the interface component 470 can be embodied as an output peripheral interface to supply output to displays (e.g., CRT, LCD, plasma, et cetera), speakers, printers, and/or other computers, among other things. Still further yet, the interface component 470 can be embodied as a network interface to enable communication with other computing devices, such as over a wired or wireless communications link.

In view of the example devices and elements described herein, or independent thereof, methodologies that may be implemented in accordance with the disclosed subject matter will be better appreciated with reference to the flow charts. While for purposes of simplicity of explanation, the methodologies are shown and described as a series of block steps, the claimed subject matter is not limited by the order of the block steps, as some block steps may occur in different orders and/or concurrently with other block steps from what is depicted and described herein. Moreover, not all illustrated block steps may be required to implement the methods described herein, or other steps or aspects finding support elsewhere in the specification may be invoked without being expressly illustrated.

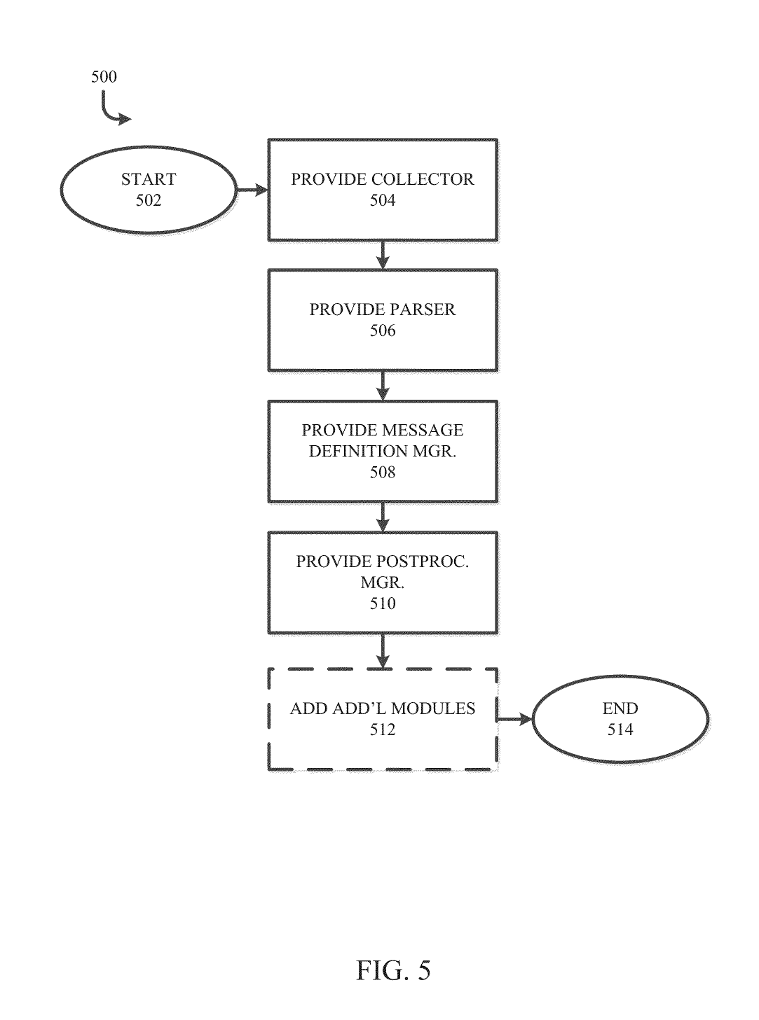

FIG. 5 illustrates a flow chart of an example methodology 500 for processing sensor data. Methodology 500 begins at 502 and proceeds to 504 where at least one collector is provided. The collector at least receives data from, and in embodiments transmits and receives data with, at least one sensor. At 506, a parser is provided which parses at least a portion of data received via the collector provided at 504. At 508, a message definition manager is provided. The message definition manager can define and populate templates, save unpopulated and populated templates, and perform other actions associated with message definitions constructed at least in part from a portion of data from a sensor. At 510, a postprocessing manager is provided which can define, display, save, and edit processing scripts to be run on at least a portion of data from a sensor.

At 512, additional modules can optionally be added (if desired/present). For example, various pre-processing modules (e.g., enabling communication between a collector and sensor, converting sensor data before it is parsed) can be added to provide the system. Thereafter, at 514, methodology 500 ends.

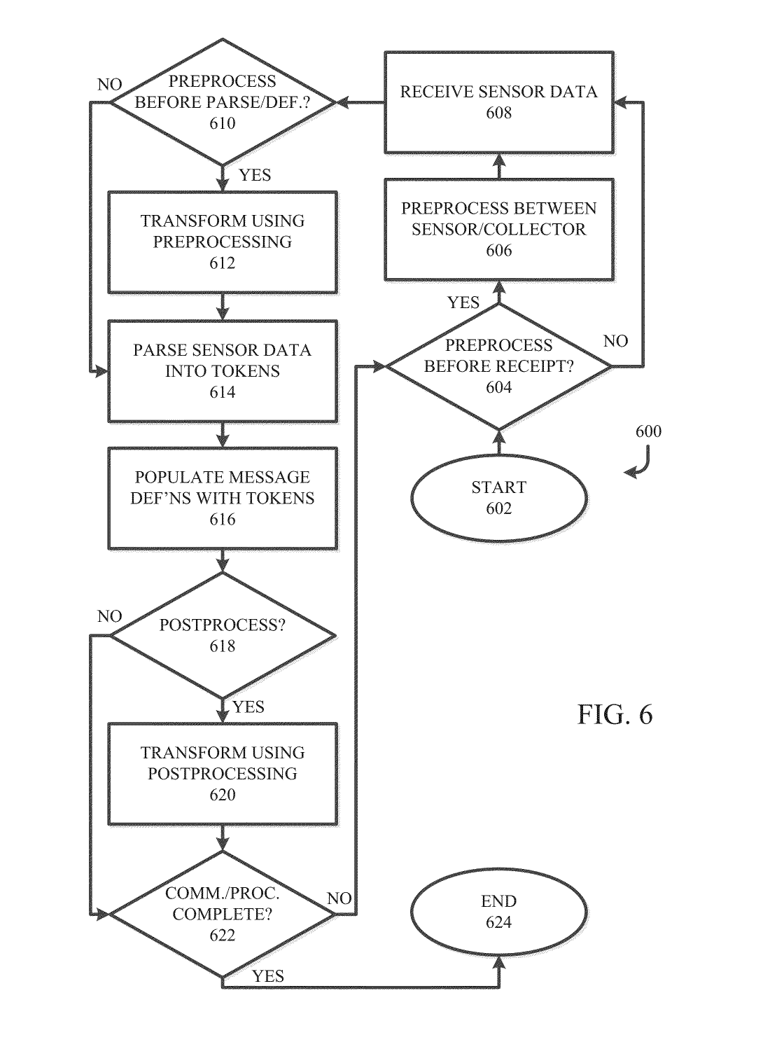

Turning now to FIG. 6, illustrated is a flow chart of an example methodology 600 for processing sensor data. Methodology 600 begins at 602 and proceeds to 604 where a determination is made as to whether any preprocessing occurs before sensor data can be received. If the determination at 604 returns positive, such as when handshake information is provided to place a collector and sensor in communication, methodology proceeds to 606 where such pre-receipt preprocessing occurs.

If the determination at 604 returns negative, or after preprocessing at 606, sensor data is received at 608. Methodology 600 then proceeds to 610, where a determination is made as to whether any further preprocessing occurs prior to parsing at 614. If the determination at 610 returns positive, one or more preprocessing scripts are run on the sensor data received at 608.

If the determination at 610 returns negative, or after preprocessing at 612, the sensor data is parsed into tokens at 614. Thereafter, one or more message definitions are populated with at least one of the parsed tokens at 616. Following population of message definitions with the tokens, a determination is made at 618 as to whether postprocessing should occur on any portion of message definitions or received sensor data. If the determination at 618 returns positive, methodology 600 proceeds to 620 where one or more postprocessing routines or scripts are run to transform the relevant data.

If the determination at 618 returns negative, or after postprocessing at 620, a determination is made at 622 as to whether communication (e.g., incoming sensor data, ongoing communication with sensor) and/or processing (e.g., preprocessing, parsing, message definition population, postprocessing) is complete. If the determination at 622 returns negative, methodology 600 recycles to complete processing. While methodology 600 is depicted as recycling to 604, methodology 600 can recycle to other steps, or performs steps in orders other than that shown, in response to the determination at 622 or in alternative embodiments. If the determination at 622 returns positive, methodology 600 proceeds to end at 624.

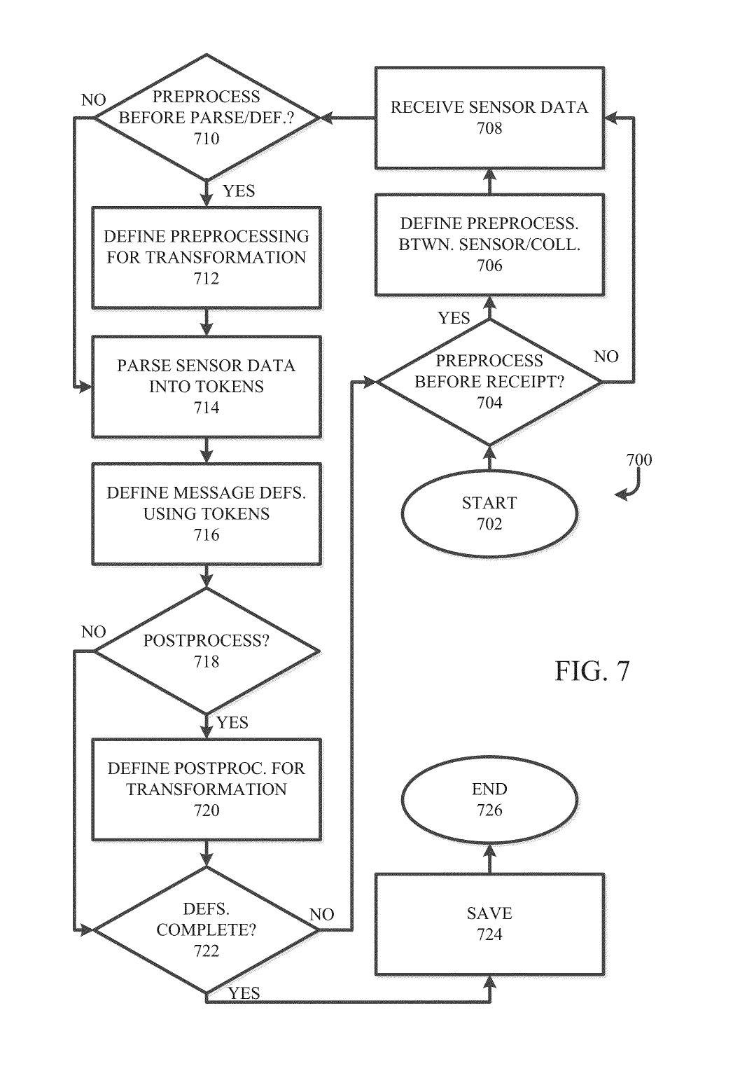

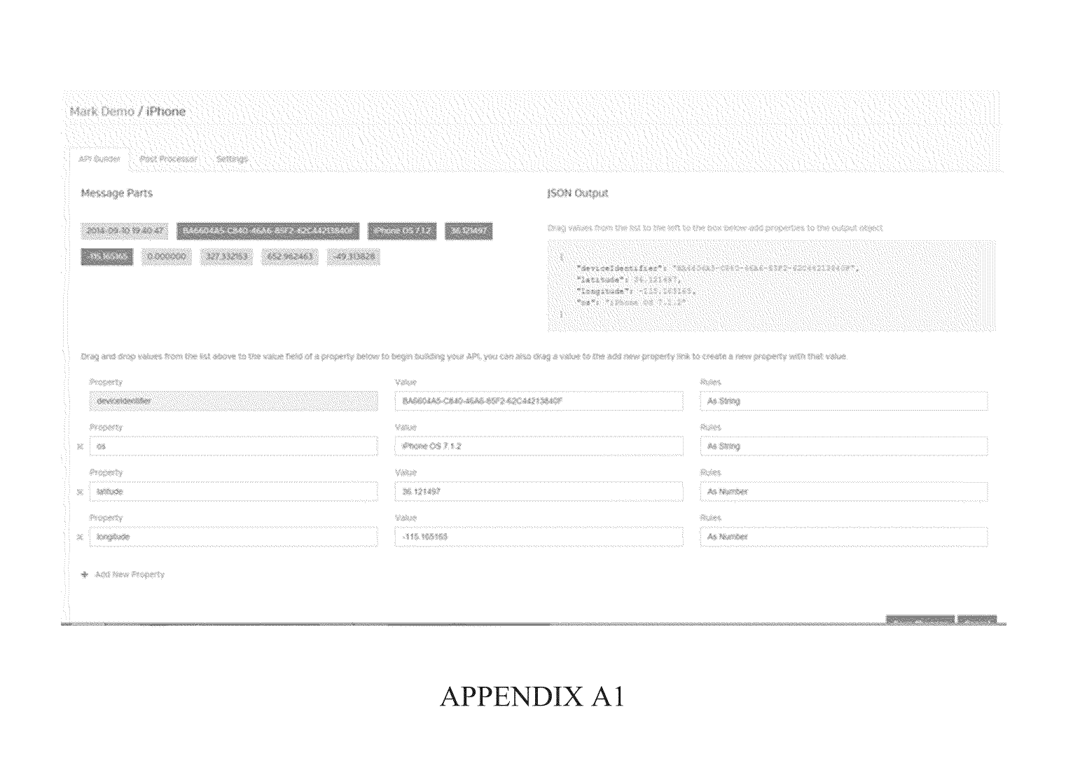

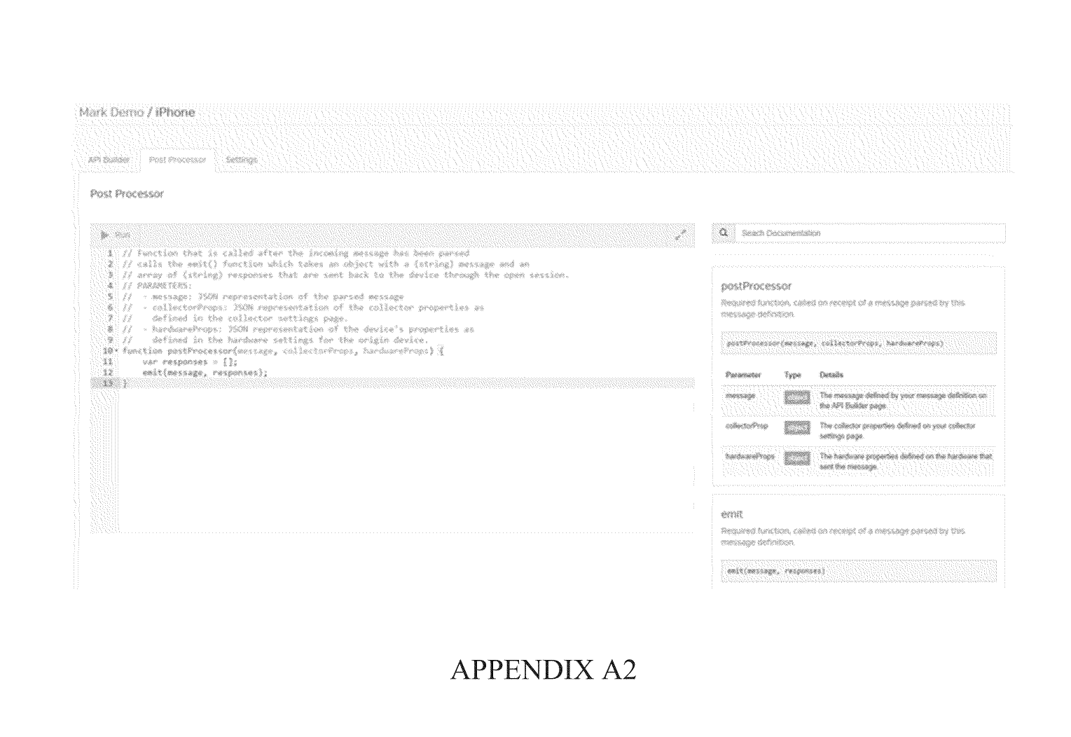

FIG. 7 illustrates a flow chart of an example methodology 700 for defining sensor data processing routines. Methodology 700 begins at 702 and proceeds to 704 where a determination is made as to whether any preprocessing occurs before sensor data can be received. If the determination at 704 returns positive, such as when handshake information is provided to place a collector and sensor in communication, methodology proceeds to 706 where such pre-receipt preprocessing is defined (e.g., by a user creating message definitions, in accordance with pre-configured settings associated with a sensor and/or collector, in accordance with a template).

If the determination at 704 returns negative, or after preprocessing at 706, sensor data is received at 708. Methodology 700 then proceeds to 710, where a determination is made as to whether any further preprocessing occurs prior to parsing at 714. If the determination at 710 returns positive, one or more preprocessing scripts are run on the sensor data received at 708.

If the determination at 710 returns negative, or after preprocessing at 712, the sensor data is parsed into tokens at 714. Thereafter, one or more message definitions are populated with at least one of the parsed tokens at 716. Following population of message definitions with the tokens, a determination is made at 718 as to whether postprocessing should occur on any portion of message definitions or received sensor data. If the determination at 718 returns positive, methodology 700 proceeds to 720 where one or more postprocessing routines or scripts are run to transform the relevant data.

If the determination at 718 returns negative, or after defining postprocessing at 720, a determination is made at 722 as to whether communication (e.g., incoming sensor data, ongoing communication with sensor) and/or processing (e.g., preprocessing, parsing, message definition population, postprocessing) is complete. If the determination at 722 returns negative, methodology 700 recycles to complete processing. While methodology 700 is depicted as recycling to 704, methodology 700 can recycle to other steps, or performs steps in orders other than that shown, in response to the determination at 722 or in alternative embodiments. If the determination at 722 returns positive, methodology 700 proceeds to end at 724.

While the methodologies of FIGS. 5-7 depict various example methods, these methods are illustrated to suggest the scope and spirit of, rather than exhaustively detail, methodologies herein. On review of the disclosure, it is understood that other aspects or variants, described by portions of the text and drawings not directed to methods, are equally embraced when explained or enacted through methodology, and other steps or aspects can be utilized in conjunction with methods herein without exceeding the understood bounds of the invention.

FIGS. 5-7 can be implemented using various hardware elements alone or in conjunction with additional software as described throughout. For example, in providing various aspects of the methodologies depicted, hardware servers, hardware network elements (wired and wireless), end-user devices (e.g., desktop computer, mobile computer, tablet or phone devices), nontransitory and/or non-volatile computer readable media (alone or in combination with computing devices), and other hardware can be utilized. These and other hardware components can also be employed when receiving and processing data, or defining the techniques by which data will be processed.

In the specification and claims, reference will be made to a number of terms that have the following meanings. The singular forms “a”, “an” and “the” include plural referents unless the context clearly dictates otherwise. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

As utilized herein, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Illustrative embodiments are described herein to illustrate the spirit of the invention rather than detail an exhaustive listing of every possible variant. It will be apparent to those skilled in the art that the above devices and methods may incorporate changes and modifications without departing from the general scope of the claimed subject matter. It is intended to include all such modifications and alterations within the scope of the claimed subject matter. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system comprising:
a collector of a web service that processes incoming traffic from a network-enabled device over a predefined communication channel;
a parser that parses the incoming traffic into elements;
a message definition manager that populates one or more message definitions using the elements; and
a postprocessing manager that modifies at least a portion of at least one of the one or more message definitions through a scripted function to produce a final message definition.

2. The system of claim 1, wherein the scripted function is defined by JavaScript code provided by a user through the web service.

3. The system of claim 1, further comprising a message definitions module that stores the one or more message definitions.

4. The system of claim 1, further comprising an analytics module that records data related to at least one of the collector, the network-enabled device, or the one or more message definitions over time.

5. The system of claim 1, further comprising a preprocessing module that modifies at least one of the incoming traffic or the elements before population of the one or more message definitions.

6. The system of claim 1, further comprising an account module that stores information about a user of the web service, the user is associated with the network-enabled device.

7. The system of claim 6, wherein the account module manages access to the one or more message definitions and the postprocessing manager via the web service.

8. The system of claim 1, further comprising an API of the web service configured to communicate with at least a portion of the one or more message definitions to a node.

9. A method comprising:
providing a collector via a web service that processes incoming traffic from a network-enabled device over a predefined communication channel;
providing a parser that parses the incoming traffic into elements;
providing a message definition manager that populates one or more message definitions using the elements; and
providing a postprocessing manager that modifies at least a portion of at least one of the one or more message definitions through a scripted function.

10. The method of claim 9, further comprising providing a graphical user interface that displays a visual representation of at least one of the incoming traffic and/or the parsed elements, wherein the graphical user interface permits moving of at least a portion of the at least one of the incoming traffic, the parsed elements, and/or the one or more message definitions on screen to modify message definitions.

11. The method of claim 10, further comprising providing a code editor that permits editing of at least the scripted function.

12. The method of claim 11, wherein the scripted function is defined by JavaScript code provided by a user.

13. The method of claim 9, further comprising providing a message definitions module that manages storage of the one or more message definitions.

14. The method of claim 9, further comprising providing an analytics module that records data related to at least one of the collector, the network-enabled device, or the one or more message definitions over time.

15. The method of claim 9, further comprising providing a preprocessing module that modifies at least one of the incoming traffic or the elements before population of the one or more message definitions.

16. The method of claim 9, further comprising providing an account module that stores information about a user associated with the network-enabled device.

17. The method of claim 16, wherein the account module manages access to the one or more message definitions and the postprocessing manager.

18. The method of claim 9, further comprising providing one or more list interfaces for displaying information associated one or more of a plurality of collectors including the collector, a plurality of message definitions including the message definition, and a plurality of sensors including the network-enabled device.

19. The method of claim 9, further comprising providing an API defined at least in part by the one or more message definitions and the scripted function through which one or more nodes receive data from the incoming traffic.

20. A method comprising:
receiving sensor data from a collector;
parsing the sensor data into one or more tokens;
populating one or more message definitions using the one or more tokens;
transforming at least a portion of the one or more message definitions using scripted functions to produce commonly interpretable information; and
transmitting the commonly interpretable information to one or more nodes using an API of a web service, the API is defined at least in part by the message definitions and the scripted functions.
